(19) United States
(12) Patent Application Publication
(10) Pub. No.: US 2004/0230899 A1
(43) Pub. Date: Nov. 18, 2004

(54) Arrangements, storage mediums and methods for associating an extensible stylesheet language device description file with a non- proprietary language device description file

(76) Inventors: Marco Aurelio de Oliveira Pagnano, Sertaozinho (BR); Rodrigo Palucci Pantoni, Ribeirao Preto (BR)

Correspondence Address: BAKER & BOTTS, 30 ROCKEFELLER PLAZA, NEW YORK, NY, 10112

(21) Appl. No.: 10/436,956

(22) Filed: May 13, 2003

(51) Int. Cl. G06F 15/00

(52) U.S. Cl. 715/513

(57) ABSTRACT

An arrangement, storage medium and method are provided to associate an Extensible Stylesheet Language (“XSL”) Device Description file with a non-proprietary language Device Description file. Each of the non-proprietary language Device Description file and the XSL Device Description file is associated with a particular type of a field device, and the XSL Device Description file includes a script-type language source code. For example, the non-proprietary language Device Description file can be an Extensible Markup Language Device Description file, and the script-type language source code can include a code associated with a method of implementing the field device and/or a function performed by the field device. Moreover, the non-proprietary language Device Description file and the XSL Device Description file can be converted into a platform-independent page having the script-type language source code embedded therein.

### FIELD OF THE INVENTION

The present invention relates generally to an arrangement, storage medium and method for associating an Extensible Stylesheet Language (“XSL”) Device Description file with a non-proprietary language Device Description file. In particular, the present invention is directed to an arrangement, storage medium and method in which processing system associates the XSL Device Description file with the non-proprietary language Device Description file, with each of the non-proprietary language Device Description file and the XSL Device Description file being associated with a field device, and the XSL Device Description file including a script-type language source code.

### BACKGROUND OF THE INVENTION

Conventional arrangements used by processing plants generally include a number of smart field devices (e.g., temperature sensors, pressure sensors, flow-rate sensors, etc.) which control and measure parameters within a process. Each such smart field device can include several function blocks. For example, the smart field device may include one or more input blocks, output blocks, and/or control blocks. Each block of the smart field device can include one or more parameters (e.g., an attribute of the block which characterizes, affects, or relates to the block). For example, parameters can describe whether the block is an input block, an output, or a control block. The parameters can also describe the maximum operating/measurement range of the block, the mode of the block, the value of the block measurement, etc. Moreover, each parameter includes one or more properties, and each property may describe a portion of the information associated with the parameter. For example, these properties can describe the name of the parameter (e.g., temperature), the value (e.g., a temperature) measured by the smart field device, the units in which the measured value is expressed (e.g., degrees centigrade or degrees Fahrenheit), etc.

Moreover, Device Description Languages (“DDL”), DDL source files, and Device Description Services have been developed to allow a user (e.g., an employee of the processing plant) to communicate with various smart field devices which are used in the process. The DDL Language is a human-readable language that provides, for example, a protocol for describing the data available from a particular smart field device, the meaning of the data retrieved from such smart field device, the format for communicating with the smart field device to obtain data, user interface information about this device (e.g., displays and menus), parameters of the field device, etc. Nevertheless, it will be understood by those of ordinary skill in the art that a Device Description can provide any information associated with the field device, such as any information used to implement the field device. The DDL source file is a human-readable text that is generally written by developers working on the smart field device. In order to generate the DDL source file for a particular smart field device, the developer can use the DDL to describe core parameter that are characteristics of the device. For example, different DDL source files may be associated with various types of the smart field devices (e.g., one DDL source file may be associated with a first pressure sensor, and another DDL source file can be associated with a second pressure sensor).

In the conventional arrangements, the source code of the DDL source file is generally compiled into binary format using a tokenizer to generate a machine-readable file known as a binary coded device description file. Each binary coded Device Description file may be forwarded to a developer of a host application. Alternatively, in the case when a particular protocol e.g., PROFIBUS™ protocol is used, the source code of the source file is forwarded to the developer of such application. Subsequently, the developer can develop the host application, and may also make available the host application, the binary coded Device Description files and/or the source code of the DDL source files to an end user. Moreover, the end user may record the binary coded Device Description files and/or the source code of the DDL source files on a storage device of a host processing system (e.g., memory, hard drive, etc.), and the host processing system can decode the binary coded Device Description file and/or the source code of the DDL source files using the interpreter Device Description Service. The host processing system may then display the decoded information to the end user.

Nevertheless, in the conventional arrangements, the binary coded Device Description file and/or the source code of the DDL source file associated with each type of the smart field devices are generally stored on the storage device of the host processing system, which may decrease the amount of memory or recordable space available to the host processing system for implementing additional applications. Further, the end user generally continuously downloads or installs the most recent version of the binary coded Device Description file and/or the source code of the DDL source file whenever the binary coded Device Description file or the source code is modified or updated. Moreover, the developer of the host application must purchase the interpreter in order to develop the host application. Nevertheless, the developer may be unable to purchase the interpreter, e.g., only a particular company may have access to the interpreter for a particular open smart communication protocol.

### SUMMARY OF THE INVENTION

Therefore, a need has arisen to provide an arrangement and method for converting a proprietary language Device Description file and/or a DDL source code associated with a field device into a non-proprietary language Device Description file, and for associating an Extensible Stylesheet Language (“XSL”) Device Description with the non-proprietary language Device Description file, thus overcoming the above-described and other shortcomings of the prior art.

One of the advantages of an arrangement and method according to the present invention, a proprietary language Device Description file and/or a Device Description language (“DDL”) source code associated with a field device may be converted into a non-proprietary language Device Description file. An Extensible Stylesheet Language (“XSL”) Device Description file including a script-type language source code can be associated with the non-proprietary language Device Description file. The script-type language source code may include code associated with one or more techniques for implementing the field device and/or one or more functions performed by the field device. Moreover, the non-proprietary language Device Description file and the XSL Device Description file can be transmitted to the host processing system. The host processing system (e.g., a parser of the host processing system) may convert the non-proprietary language Device Description file and the XSL Device Description file into a platform-independent file/page having the script-type language source code embedded therein.

The platform-independent file/page also may include a link to the one or more methods for implementing the field device and/or one or more functions performed by the field device. When the link is selected by the user of the host processing system, the host processing system may execute the script-type language source code. Consequently, the host processing system does not have to receive and download the proprietary language Device Description file, thus increasing the amount of storage that may be available to the host processing system for implementing additional applications. Further, the host processing system does not need to continually download or install the most recent version of the proprietary language Device Description file and/or the DDL source code associated with the field device when the proprietary language Device Description file and/or the DDL source code is modified.

This and other advantages can be achieved with an exemplary embodiment of the arrangement, a logic arrangement, a storage medium, a software arrangement and/or method according to the present invention. In particular, a processing system (e.g., a first system) can associate a particular Extensible Stylesheet Language (“XSL”) Device Description file with a particular non-proprietary language Device Description file (e.g., a particular non-binary coded Device Description file, such as an Extensible Markup Language (“XML”) Device Description file). For example, the processing system may initially convert a particular proprietary language Device Description file a particular binary coded Device Description file) and/or a particular DDL source code into the particular non-proprietary language Device Description file, and may then associate the particular non-proprietary language Device Description file with the particular XSL Device Description file. Each of the particular non-proprietary language Device Description file and the particular XSL Device Description file may be associated with a particular type of the field device (e.g., a pressure sensor, a temperature sensor, a flow-rate sensor, a valve, a switch, etc.), and the particular XSL Device Description file may include a particular script-type language source code (e.g., a Javescript® language source code, a Visual Basic® language source code, etc.). For example, the particular script-type language source code can be located between tags of the XSL Device Description file, and may include a code associated with one or more methods of implementing the particular type of the field device and/or one or more functions performed by such particular type of the field device.

Moreover, the particular non-proprietary language Device Description file and the particular XSL Device Description file can be transmitted to another processing system (e.g., a second system using the Internet, an Intranet, etc.), and this second system (e.g., a parser of the second processing system) can convert the non-proprietary language Device Description file and the XSL Device Description file into a platform-independent file/page (e.g., a Hypertext Markup Language (“HTML”) file/page) having the script-type language source code embedded therein. The platform-independent file/page can include one or more parameters associated with the particular type of the field device, a link to the one or more methods for implementing the field device and/or one or more functions performed by the field device, etc. When the link is selected by a user of the second processing system (e.g., by clicking on the link), the second system may execute the script-type language source code, and can invoke and execute an operation of a particular component (e.g., an Object Linked Embedded for a Process Control component) of the first system through a remote procedure call (“RPC”) (e.g., a Web Service, DCOM, or COBRA). The particular component can establish a communication with the field device and implement/execute the one or more methods included in the script-type language source code (e.g., to configure the field device and/or obtain data from the field device). Moreover, the particular component can transmit the data obtained from the field device to the second system through the RPC, such that this second system can display such data to the user.

Alternatively, the first system (e.g., a parser thereof) may can convert the non-proprietary language Device Description file and the XSL Device Description file into the platform-independent file/page by executing the script-type language source code, and can also internally invoke and execute an operation of the particular component. The particular component can establish the communication with the field device, and implement/execute the one or more procedures included in the script-type language source code (e.g., to configure the field device and/or obtain data from the field device). Moreover, the particular component can transmit the data obtained from the field device to the second system in a platform-independent format, such that the second system can readily display such data to the user.

In addition, the first system can associate a further XSL Device Description file with a further non-proprietary language Device Description file. For example, the first processing system may initially convert a further proprietary language Device Description file and/or a further DDL source code into the further non-proprietary language Device Description file, and then can associate the further non-proprietary language Device Description file with the further XSL Device Description file. Each of the further non-proprietary language Device Description file and the further XSL Device Description file may be associated with a further type of a field device, and the further XSL Device Description file can include a further script-type language source code. For example, the further script-type language source code can include code associated with one or more methods of implementing the further type of the field device and/or one or more functions performed by the further type of the field device. Moreover, the further non-proprietary language Device Description file may be different than the particular non-proprietary language Device Description file, and the further XSL Device Description file can be different than the particular XSL Device Description file.

### BRIEF DESCRIPTION OF THE DRAWINGS

FIG. 1 a is a block diagram of a first exemplary embodiment of a system which includes a software arrangement according to the present invention for converting a proprietary language Device Description file and/or a Device Description language source code associated with a field device into a non-proprietary language Device Description file, and for associating an Extensible Stylesheet Language Device Description file with the non-proprietary language Device Description file.

FIG. 2a is a block diagram of a second exemplary embodiment of the system which includes the software arrangement according to the present invention.

FIG. 2b is a block diagram of a variation of the second exemplary embodiment of the system shown in FIG. 2a.

FIG. 2c is a block diagram of a third exemplary embodiment of the system that includes the software arrangement according to the present invention.

FIG. 3 is a block diagram of the proprietary language Device Description file converted into the non-proprietary language Device Description file, and the non-proprietary language Device Description file associated with the Extensible Stylesheet Language Device Description file according to the first exemplary embodiment of FIG. 1, the second exemplary embodiment of FIGS. 2a and 2b and/or the third exemplary embodiment of FIG. 2c.

FIG. 4a is a top-level flow diagram of a first exemplary embodiment of a method according to the present invention for converting the proprietary language Device Description file and/or the Device Description language source code associated with the field device into the non-proprietary language Device Description file, and for associating the Extensible Stylesheet Language Device Description file with the non-proprietary language Device Description file.

FIG. 4b is a top-level flow diagram of a second exemplary embodiment of the method according to the present invention.

### DETAILED DESCRIPTION

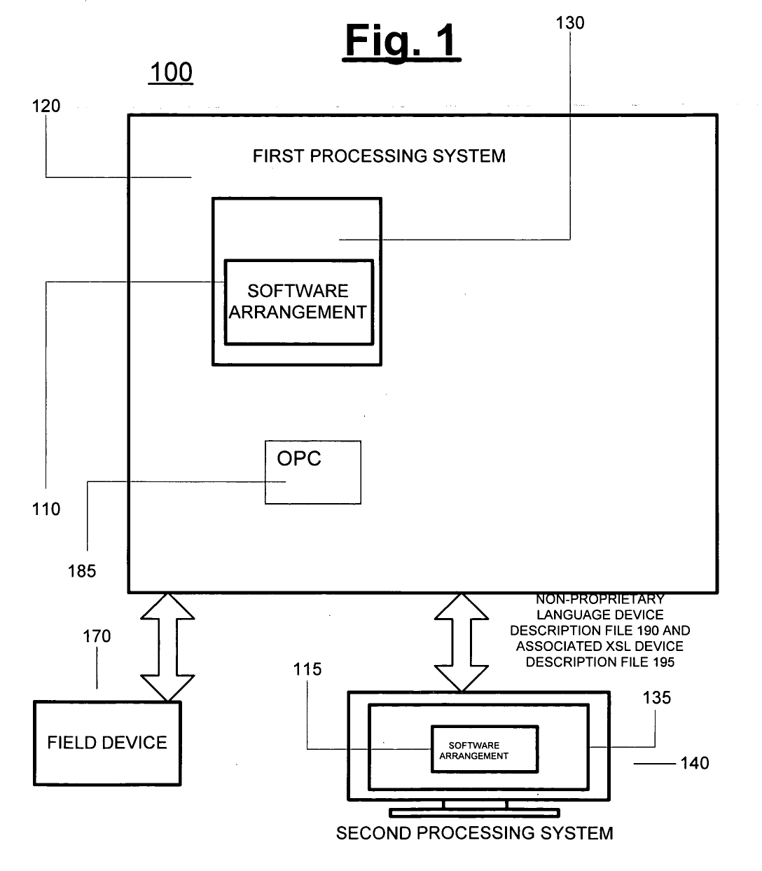

Exemplary embodiments of the present invention and their advantages may be understood by referring to FIGS. 1-4b, like numerals being used for like corresponding parts in the various drawings.

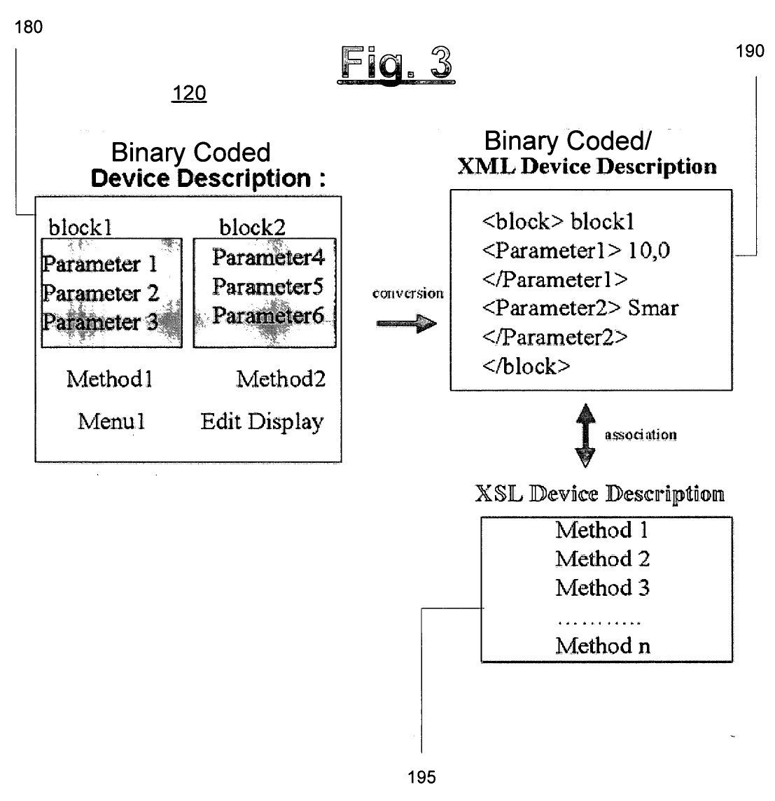

FIG. 1 shows a first exemplary embodiment of a system 100 which includes a first storage device 130 (e.g., RAM, hard drive, CD-ROM, etc.) that provides thereon a first software arrangement 110, and has a first processing system 120 (eg., a first microprocessor). Referring to FIGS. 1 and 3, this first software arrangement 110 may be executed by the first processing system 120 to convert a proprietary language Device Description file 180 shown in and/or a DDL source code associated with a certain/particular type of a field device 170 (e.g., a smart field device, such as a pressure sensor, a temperature sensor, a flow-rate sensor, etc. that are capable of performing operations) into a non-proprietary language Device Description file 190 (e.g., a non-binary coded Device Description file, such as an Extensible Markup Language (“XML”) Device Description file).

This first software arrangement 110 may also be executed by the first processing system 120 to associate an Extensible Stylesheet Language (“XSL”) Device Description file 195 (e.g., an XSL Device Description file including a script-type language source code, such as a Javescript® to language source code, a Visual Basic® language source code, etc.) with the non-proprietary language Device Description file 190. The first software arrangement 110 may configure the first processing system 120 to transmit the XSL Device Description file 195 and the associated non-proprietary language Device Description file 190. The XSL Device Description file 195 may be associated with the particular type of the field device 170. Moreover, the particular script-type language source code can be located between tags of the XSL Device Description file 195, and may include a code associated with one or more methods of implementing the field 170 and/or one or more functions performed by the field device 170.

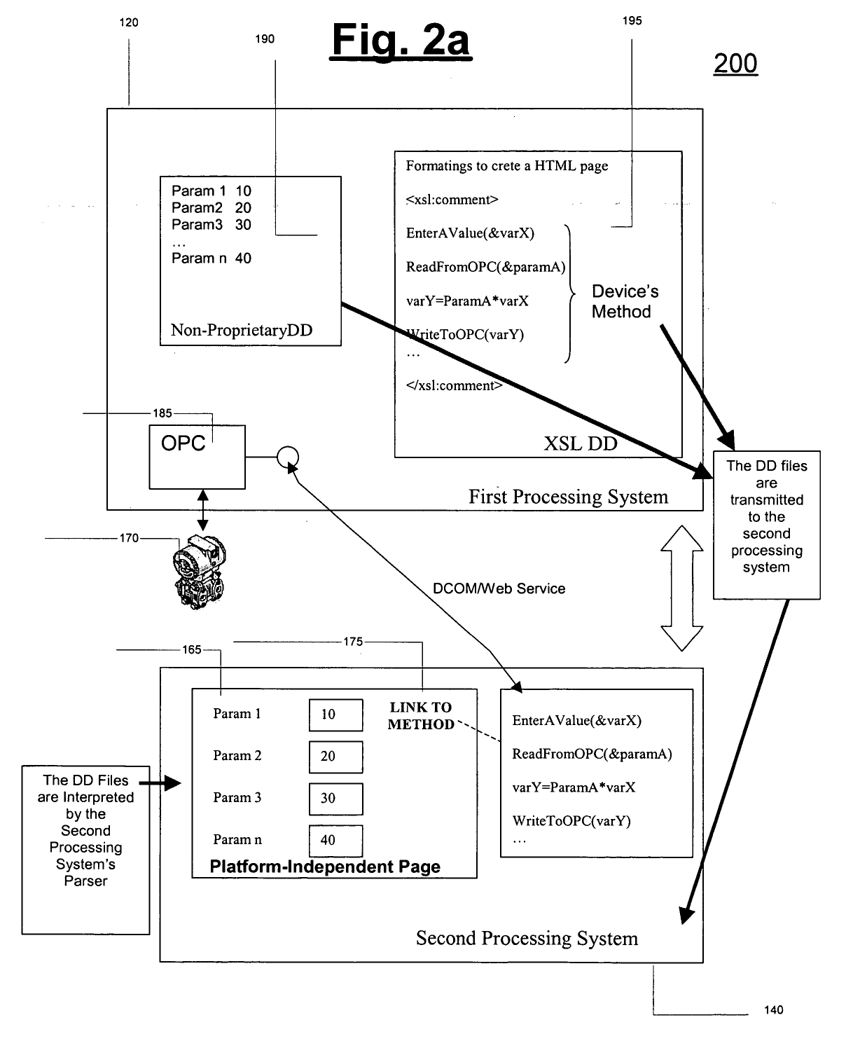

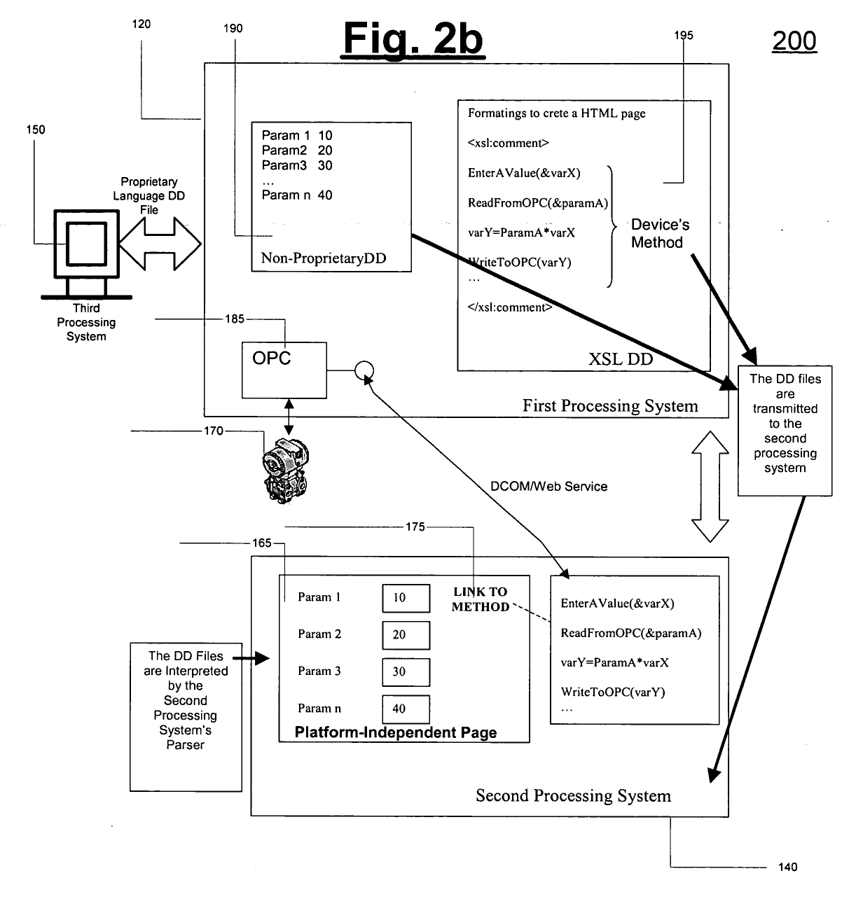

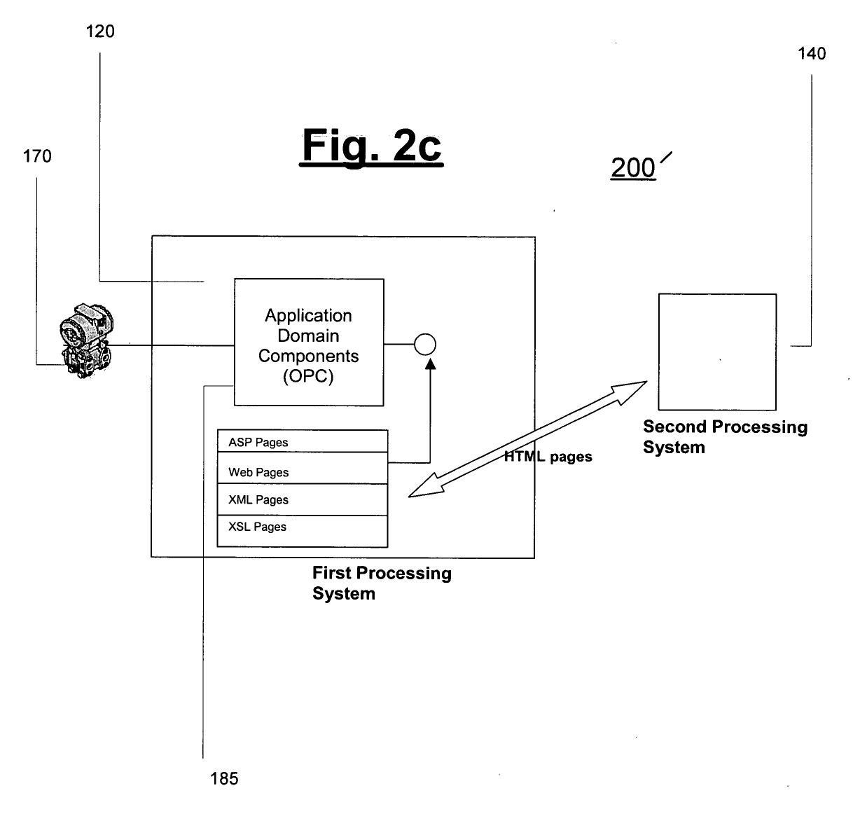

In the exemplary embodiment shown in FIG. 1, the system 100 can also include a second storage device 135 (e.g., RAM, hard drive, CD-ROM, etc.) that stores thereon a second software arrangement 115, and has a second processing system 140 (e.g., a second microprocessor). Moreover, the XSL Device Description file 195 and the associated non-proprietary language Device Description file 190 (both shown in FIG. 2a) may be transmitted to the second processing system 140. Referring to FIGS. 1 and 2a, the second software arrangement 115 can convert the non-proprietary language Device Description file 190 and the XSL Device Description file 195 into a platform-independent file/page 165 (e.g., a Hypertext Markup Language (“HTML”) file/page) having the script-type language source code embedded therein. The platform-independent file/page 165 can include one or more parameters associated with the particular type of the field device 170, a link 175 to one or more methods for implementing the field device 170 and/or one or more functions performed by the field device 170, etc.

When the link 175 is selected by a user of the second processing system 140, e.g., by clicking on the link 175, the second software arrangement 115 may execute the script-type language source code, and can also invoke and execute an operation of a particular component 185 (e.g., an Object Linked Embedded for Process Control component) of the first processing system 120 through a remote process call (“RPC”) (e.g., a Web Service, DCOM, COBRA, etc.). The particular component 185 can establish a communication with the field device 170, and implement/execute the one or more methods included in the script-type language source code, e.g., to configure the field device 170 and/or obtain data from the field device 170. Moreover, the particular component 185 can transmit the data obtained from the field device 170 to the second processing system 140 through the RPC, such that the second processing system 140 can display such data to the user.

As described above, in any of the exemplary embodiments of the present invention, the first software arrangement 110 may be resident on the first storage device 130 (e.g., a memory device, a hard drive, etc.) of the first processing system 120, and/or can also be stored on an external storage device. Instead of using the first software arrangement 110, it is possible to utilize a hardware arrangement, a firmware arrangement and/or a combination thereof which can implement the techniques described herein. Similarly, the second software arrangement 115 may be resident on the second storage device 135 (e.g., a memory device, a hard drive, etc.) of the second processing system 140, and/or can also be stored on an external storage device. Similarly to the first software arrangement 110, it is possible to utilize a hardware arrangement, a firmware arrangement and/or a combination thereof instead of using the second software arrangement 115.

Web Services that can be utilized by the exemplary embodiments of the arrangements and methods of the present invention are programmable application logic accessible using standard Internet protocols. Unlike conventional component technologies, Web Services are not accessed via object-model-specific protocols, such as the Component Object Model, Remote Method Invocation, or Internet Inter-ORB Protocol. In contrast, Web Services may be accessed via ubiquitous Web protocols and data formats, such as Hypertext Transfer Protocol (“HTTP”) and XML. Moreover, a Web Service interface may be defined in terms of messages which the Web Service accepts and/or generates, and the Web Service can be used by applications implemented in any language for any platform. In this manner, the Web Services may be platform-independent, language-independent, and reusable.

FIG. 2a shows a second exemplary embodiment of a system 200 according to the present invention which is substantially similar to the first embodiment of the system 100 illustrated in FIG. 1, except as indicated below. In this exemplary system 200, during operation, the first processing system 120 may receive the proprietary language Device Description file 180 and/or the DDL source code associated with the particular type of the field device 170 from a third processing system. For example, and referring to FIG. 2b, the third processing system 150 may be a processing system of a manufacturer of a particular field device, a developer of a host application, the Fieldbus Foundation®, etc.

Referring again to FIG. 2a, after the first processing system 120 receives the proprietary language Device Description file 180 and/or the Device Description language source code, the first processing system 120 can convert the proprietary language Device Description file 180 and/or the DDL source code into the non-proprietary language Device Description file 190. The first processing system 120 can also associate the XSL Device Description file 195 including the script-type language source code with the non-proprietary language Device Description file 190, and transmit the XSL Device Description file 195 and the associated non-proprietary language Device Description file 190 to the second processing system 140. The particular script-type language source code can include code associated with one or more techniques of implementing the field device 170 and/or one or more functions performed by the field device 170.

Moreover, the second processing system 140 (e.g., a parser of the second processing system 140) can convert the non-proprietary language Device Description file 190 and the XSL Device Description file 195 into the platform-independent file/page having the script-type language source code embedded therein. The platform-independent file/page 165 can include one or more parameters associated with the particular type of the field device 170, the link 175 to the one or more procedures or techniques for implementing the field device 170 and/or one or more functions performed by the field device 170, etc. When the link 175 is selected by the user of the second processing system 140, e.g., by clicking on the link 175, the second processing system 140 may execute the script-type language source code, and can also invoke and execute the operation of the particular component 185 (e.g., the Object Linked Embedded for Process Control component) of the first processing system 120 through the RPC. The particular component 185 can establish a communication with the field device 170 and implement/execute the one or more methods included in the script-type language source code (e.g., to configure the field device 170 and/or obtain data from the field device 170). Moreover, the particular component 185 can transmit the data obtained from the field device 170 to the second processing system 140 through the RPC, such that the second processing system 140 may display such data to the user.

FIG. 2c shows a third exemplary embodiment of a system 200′ according to the present invention, which is substantially similar to the second embodiment of the system 200 illustrated in FIG. 2a and/or FIG. 2b, except as indicated below. In this exemplary embodiment of the present invention, the first processing system 120 (e.g., the parser of the first processing system 120) may can convert the non-proprietary language Device Description file 190 and the XSL Device Description file 195 into the platform-independent file/page 165 by executing the script-type language source code, and can also internally invoke and execute the operation of the particular component 185. The particular component 185 can establish the communication with the field device 170, and implement/execute the one or more techniques or procedures included in the script-type language source code, e.g., to configure the field device 170 and/or obtain data from the field device 170. Moreover, the particular component 185 can transmit the data obtained from the field device 170 to the second processing system 140 through the RPC in a platform-independent format, such that the second processing system 140 may readily display such data to the user.

It will be readily understood by those of ordinary skill in the art that the system 100, 200 illustrated in FIGS. 1, 2a and/or 2b may be used to associate different non-proprietary language Device Description files with various corresponding XSL Device Description files. Also, that the non-proprietary language Device Description files and the corresponding XSL Device Description files may be associated with different types of the field devices.

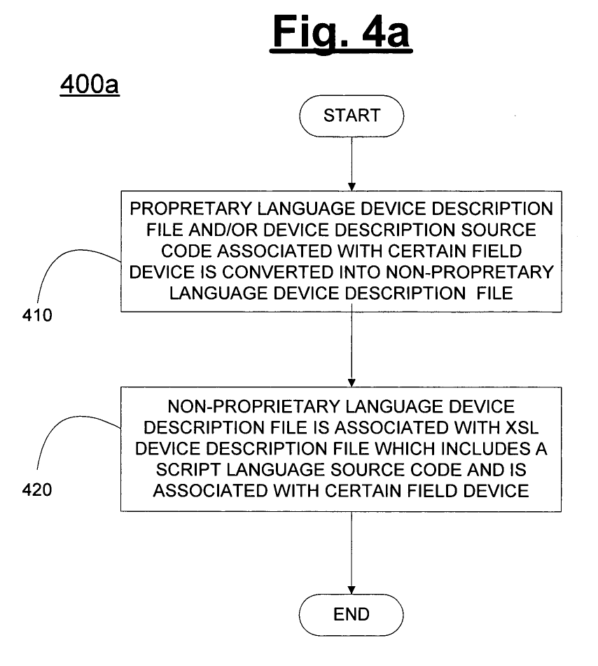

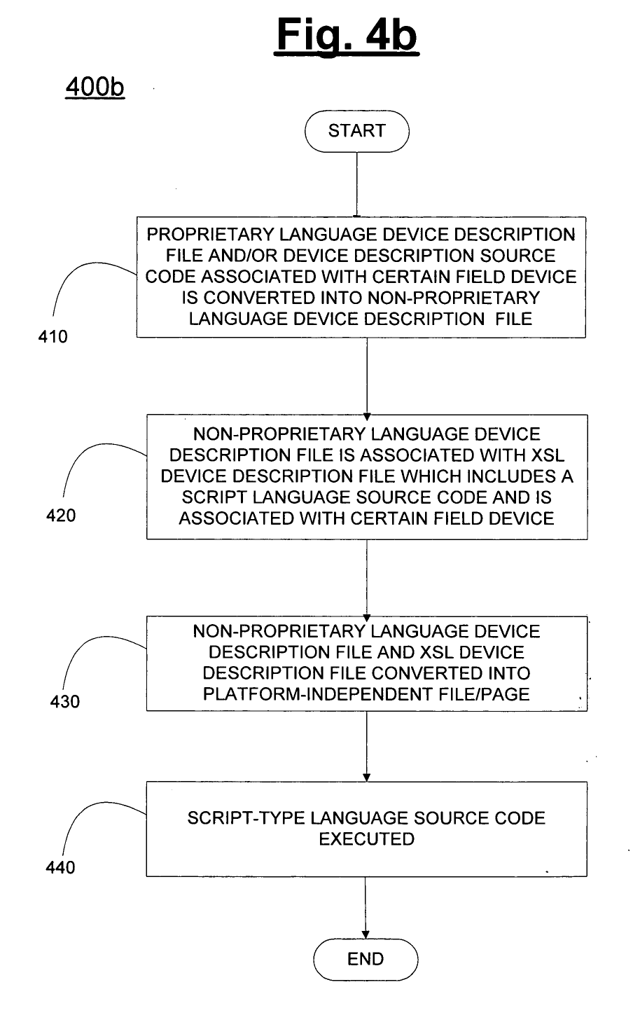

FIG. 4a shows a first exemplary embodiment of a method 400a according to the present invention for converting the proprietary language Device Description file 180 and/or the Device Description language source code associated with the field device 170 into a non-proprietary language Device Description file 190, and for associating the XSL Device Description file 195 with the non-proprietary language Device Description file 190. Particularly, in step 410, the proprietary language Device Description file 180 and/or the Device Description language source code associated with a certain type of the field device 170 is converted into the non-proprietary language Device Description file 190 (e.g., by the first processing system 120). Then, in step 420, the non-proprietary language Device Description file 190 is associated with the XSL Device Description file 195. The XSL Device Description file 195 includes the script-type language source code. Moreover, the XSL Device Description file 195 is associated with the particular type of the field device 170.

FIG. 4b shows a second exemplary embodiment of a method 400b according to the present invention. The exemplary method 400b includes steps 410 and 420 of the method 400a of FIG. 4a, and also has steps 430 and 440. In step 430, the non-proprietary language Device Description file 190 and the XSL Device Description file 195 are converted (e.g., by the second processing system 140) into the platform-independent file/page 165 (e.g., a HTML file/page) having the script-type language source code embedded therein. Further, in step 440, the script-type language source code may be executed (e.g., by the second processing system 140). Specifically, the script-type language source code may be executed and transmitted to the particular component 185. The particular component 185 then may a communication with the field device 170, and implement/execute the one or more techniques/procedures included in the script-type language source code (e.g., to configure the field device 170 and/or obtain data from the field device 170). Moreover, the particular component 185 can transmit the data obtained from the field device 170 to the second processing system 140, such that the second processing system 140 may display such data to the user.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. It is intended that the specification and the described examples are considered as exemplary only, with the true scope and spirit of the invention indicated by the following claims.

FIG. 2b shows a second exemplary embodiment of a system 200 according to the present invention which is substantially similar to the first embodiment of the system 100 illustrated in FIG. 1, except as indicated below. In this exemplary system 200, during operation, the first processing system 120 may receive the proprietary language Device Description file 180 and/or the DDL source code associated with the particular type of the field device 170 from a third processing system. For example, and referring to FIG. 2b, the third processing system 150 may be a processing system of a manufacturer of a particular field device, a developer of a host application, the Fieldbus Foundation®, etc.

1. An arrangement, comprising:
a processing system operable to associate a particular Extensible Stylesheet Language (“XSL”) Device Description (“DD”) file with a particular non-proprietary language DD file, wherein each of the particular non-proprietary language DD file and the particular XSL DD file is associated with a particular type of a field device, and wherein the particular XSL DD file comprises a particular script-type language source code.

2. The arrangement of claim 1, wherein the particular script-type language source code is one of a Javascript® language source code and a Visual Basic® language source code.

3. The arrangement of claim 1, wherein the non-proprietary language DD file is an Extensible Markup Language (“XML”) DD file, and wherein the particular script-type language source code comprises code associated with at least one procedure for implementing the particular type of the field device.

4. The arrangement of claim 1, wherein the particular type of the field device is one of a pressure sensor, a temperature sensor, a flow-rate sensor, a valve and a switch.

5. The arrangement of claim 1, wherein the processing system is further operable to convert at least one of a particular proprietary language DD file and a particular Device Description Language (“DDL”) source code associated with the particular type of the field device into the particular non-proprietary language DD file.

6. The arrangement of claim 5, wherein the processing system is further operable to convert the particular non-proprietary language DD file and the particular XSL DD file into a platform-independent file which does not comprise the script-type language source code embedded therein, and to transmit the platform-independent file to a further processing arrangement.

7. The arrangement of claim 6, wherein the processing system is further operable to transmit the particular non-proprietary language DD file and the particular XSL DD file to a further processing system, and wherein the further processing system is operable to convert the particular non-proprietary language DD file and the particular XSL DD file into a platform-independent file having the script-type language source code embedded therein.

8. The arrangement of claim 7, wherein the platform-independent file is a Hypertext Markup Language (“HTML”) file.

9. The arrangement of claim 8, wherein the HTML file comprises at least one link associated with at least one method for implementing the particular type of the field device.

10. The arrangement of claim 9, wherein the non-proprietary language DD file is a non-binary Device Description file.

11. The arrangement of claim 10, wherein the non-binary DD file is an Extensible Markup Language (“XML”) DD file.

12. The arrangement of claim 10, wherein the further processing system is further operable to execute the script-type language source code, and to invoke and execute an operation of a particular component of the processing system through a remote procedure call (“RPC”).

13. The arrangement of claim 12, wherein the particular component is an Object Linked Embedded For Process Control component, and wherein the RPC is a Web Service.

14. The arrangement of claim 13, wherein the particular component is operable to establish a communication with the particular type of the field device.

15. The arrangement of claim 13, wherein the particular script-type language source code comprises a code associated with at least one procedure for implementing the particular type of the field device, and wherein the particular component is operable to directly or indirectly execute the at least one procedure for implementing the particular type of the field device.

16. The arrangement of claim 4613, wherein the particular component is further operable to directly or indirectly configure the particular type of the field device, obtain data from the particular type of the field device, and transmit the data to the further processing system.

17. The arrangement of claim 1, wherein the processing system is further operable to associate a further XSL DD file with a further non-proprietary language DD file, wherein the further non-proprietary language DD file is associated with a further type of a field device, wherein the further XSL DD file comprises a further script-type language source code, and wherein the further non-proprietary language DD file is different than the particular non-proprietary language Device Description file.

18. A logic arrangement, which, when executed by a processing system, configures the processing system to perform the steps comprising of:
converting at least one of a proprietary language Device Description (“DD”) file and a Device Description Language source code associated with a particular type of a field device into a non-proprietary language DD file; and
associating an Extensible Stylesheet Language (“XSL”) DD file with the non-proprietary language DD file, wherein the XSL DD file is associated with the particular type of the field device, and wherein the XSL DD file comprises a script-type language source code.

19. A storage medium including executable instructions thereon, wherein, when the executable instructions are executed by a processing system, the executable instructions configure the processing system to perform the steps comprising of:
converting at least one of a proprietary language Device Description (“DD”) file and a Device Description Language (“DDL”) source code associated with a particular type of a field device into a non-proprietary language DD file; and
associating an Extensible Stylesheet Language (“XSL”) DD file with the non-proprietary language DD file, wherein the XSL DD file is associated with the particular type of the field device, and wherein the XSL DD file comprises a script-type language source code.

20. A software arrangement, which is operable to be executed by a processing system to perform the steps comprising of:
converting at least one of a proprietary language Device Description (“DD”) file and a Device Description Language source code associated with a particular type of a field device into a non-proprietary language DD file; and
associating an Extensible Stylesheet Language (“XSL”) DD file with the non-proprietary language DD file, wherein the XSL DD file is associated with the particular type of the field device, and wherein the XSL DD file comprises a script-type language source code.

21. A method, comprising the steps of:
converting at least one of a particular proprietary language DD (“DD”) file and a particular Device Description Language (“DD”) source code associated with a particular type of a field device into a particular non-proprietary language DD file; and
associating a particular Extensible Stylesheet Language (“XSL”) Device Description file with the particular non-proprietary language DD file, wherein the particular XSL DD file is associated with the particular type of the field device, and wherein the particular XSL Device Description file comprises a particular script-type language source code.

22. The method of claim 21, wherein the particular script-type language source code is one of a Javascript® language source code and a Visual Basic® language source code.

23. The method of claim 21, wherein the non-proprietary language DD file is an Extensible Markup Language (“XML”) DD file.

24. The method of claim 21, wherein the particular type of the field device is one of a pressure sensor, a temperature sensor, a flow-rate sensor, a valve and a switch.

25. The method of claim 21, wherein the particular script-type language source code comprises a code associated with at least one method for implementing the particular type of the field device.

26. The method of claim 21, further comprising the step of transmitting the particular non-proprietary language DD file and the particular XSL DD file to a remote processing system.

27. The method of claim 26, further comprising the step of converting the particular non-proprietary language DD file and the particular XSL DD file into a platform-independent file having the script-type language source code embedded therein.

28. The method of claim 27, wherein the platform-independent file is a Hypertext Markup Language (“HTML”) file.

29. The method of claim 28, wherein the HTML file comprises at least one link associated with at least one method for implementing the particular type of the field device.

30. The method of claim 29, wherein the non-proprietary language DD file is a non-binary DD file.

31. The method of claim 30, wherein the non-binary DD file is an Extensible Markup Language (“XML”) DD file.

32. The method of claim 30, further comprising the step of executing the script-type language source code.

33. The method of claim 20, further comprising the steps of:
converting at least one of a further proprietary language DD file and a further DDL source code associated with a further type of a field device into a further non-proprietary language DD file; and
associating a further Extensible Stylesheet Language (“XSL”) DD file with the further non-proprietary language DD file, wherein the further XSL Device Description file is associated with the further type of the field device, wherein the further XSL DD file comprises a further script-type language source code, and wherein the further non-proprietary language DD file is different than the particular non-proprietary language DD file.

34. The arrangement of claim 1, wherein the field device includes a sensing device.

35. The logic arrangement of claim 18, wherein the field device includes a sensing device.

36. The storage medium of claim 19, wherein the field device includes a sensing device.

37. The software arrangement of claim 20, wherein the field device includes a sensing device.

38. The method of claim 21, wherein the field device includes a sensing device.
